(19) United States
(12) Patent Application Publication
(10) Pub. No.: US 2020/0070600 A1
(43) Pub. Date: Mar. 5, 2020

(54) IMPROVED INFLATION VALVE FOR TYRE

(71) Applicant: SCHRADER, Pontarlier (FR)

(72) Inventors: Sébastien ROBERT, Besancon (FR); Benoit GRESSET, Arbois (FR); Jérôme Puppis, Pontarlier (FR)

(21) Appl. No.: 16/614,025

(22) PCT Filed: May 15, 2018
(86) PCT No.: PCT/EP2018/062563

§ 371 Date: Nov. 15, 2019

(30) Foreign Application Priority Data
May 16, 2017 (FR) 1754289
Jul. 7, 2017 (FR) 1756476

(51) Int. Cl. B60C 29/00; B60C 29/02; B60C 23/04

(52) U.S. Cl. CPC B60C 29/002; B60C 23/0494; B60C 29/02

(57) ABSTRACT

The tire inflation valve comprising a tube defining a passage and having an inside end and an outside end, a valve mechanism positioned in the passage, the valve mechanism comprising a valve shutter and a seat arranged so as to cooperate sealingly with each other, the seat being arranged on the tube in the passage.

### TECHNICAL FIELD

The invention relates to a tire inflation valve of the type intended to inflate a tubeless-type tire. This inflation valve is referred to as “tubeless” or even as a “TPMS” (“Tire Pressure Monitoring System”) if it includes a system for monitoring the pressure of the tire using a sensor associated with the valve. It is of the “snap-in” type if it is snapped or locked onto the wheel rim, or of the “clamp-in” type if it is screwed onto the wheel rim.

### BACKGROUND ART

Tire inflation valves are currently at least formed by two parts, i.e. the valve body and the valve mechanism. The valve mechanism includes the valve shutter and the associated seat thereof, allowing the pressure inside the tire to be checked and adjusted. It is assembled such that it is attached, generally in a screwed manner, at the outside end of the valve body, which outside end is accessible from the outside of the tire. Such assemblies are described in the patent document EP 0 958 947, for example, incorporated herein by reference. One drawback of such a mounted assembly is due to the fact that the outer dimensions of the outside end of the valve body are restricted by a standard and due to the fact that the screwed valve mechanism requires the presence of a tapping within the outside end: as a result, the material thickness of the valve body is reduced and thus the mechanical strength of the valve body is also reduced, at least at the outside end thereof, where the fixed screwed valve mechanism is located. This creates risks of valve failure. More specifically, breakage of the outside end of the valve body no longer guarantees airtight sealing of the pressurized volume of the tire according to two modes of failure:

An immediate loss of airtightness, whereby the tire deflates and the vehicle becomes immobilized;

The valve mechanism remains in place, despite the breakage of the outside end of the valve body, however the maintenance thereof in place is severely compromised. The tire can function normally, however the loss of airtightness and relatively fast leakage can occur in a random manner upon the slightest movement or engagement of the valve mechanism (for example rolling vibrations) and thus endanger the one or more users of the vehicle.

### SUMMARY

One purpose of embodiments of the invention is to provide a tire inflation valve that does not suffer from the aforementioned drawbacks.

For this purpose, the invention relates to a tire inflation valve including a tubular body defining a passage and having an inside end and an outside end, a valve mechanism positioned in the passage, the valve mechanism including a valve shutter and a seat arranged so as to engage with one other in an airtight manner, characterized in that the seat is arranged on the tubular body in the passage.

Thus, by providing the seat of the valve mechanism on the valve body, a mechanism body foreign to the valve body is no longer required since the valve body acts as the mechanism body. This procures optimal mechanical strength ensuring an optimal airtight seal.

Advantageously but optionally, the inflation valve according to embodiments of the invention has at least one of the following additional features:

the seat is located in an area of a limited mechanical load area of the tubular body;

the seat is located in the vicinity of an orifice of the tire rim during assembly of the inflation valve;

the seat is located at the inside end of the tubular body such that it is positioned inside the tire during assembly of the inflation valve;

the valve mechanism comprises structure for controlling the valve shutter which are situated at the outside end of the tubular body;

the valve mechanism includes a valve stem comprising a head forming the valve shutter including a sealing member arranged so as to engage in an airtight manner with the seat of the tubular body;

the valve mechanism includes a valve stem comprising a head forming the valve shutter arranged so as to engage in an airtight manner with a sealing member arranged on the seat of the tubular body;

the valve mechanism includes a return mechanism for returning to the closed position which are situated at the outside end of the tubular body;

the return mechanism comprises a spring;

the spring includes, at one end, a first coil 4131 bearing against a bearing edge of the tubular body in the passage and, at an opposite end, a coil connected to the valve shutter and a widened guiding and stabilization coil; and

the valve stem includes a bulge engaging with the coil.

### BRIEF DESCRIPTION OF HTE DRAWINGS

Other features and advantages of embodiments of the invention will appear upon reading the following description given of one embodiment of the invention. In the accompanying drawings:

FIG. 1 is a three-dimensional view of an inflation valve according to an embodiment of the invention;

FIG. 2 is a side view of the inflation valve in FIG. 1;

FIG. 3 is a sectional view along of the inflation valve in FIG. 2;

FIG. 4 is a sectional view of an inflation valve without a casing;

FIG. 5 is a three-dimensional view of the inflation valve in FIG. 4;

FIG.6 is a sectional view of a second embodiment of an inflation valve without a casing; and,

FIG. 7 is a three-dimensional view of the assembly of the valve stem and the return mechanism.

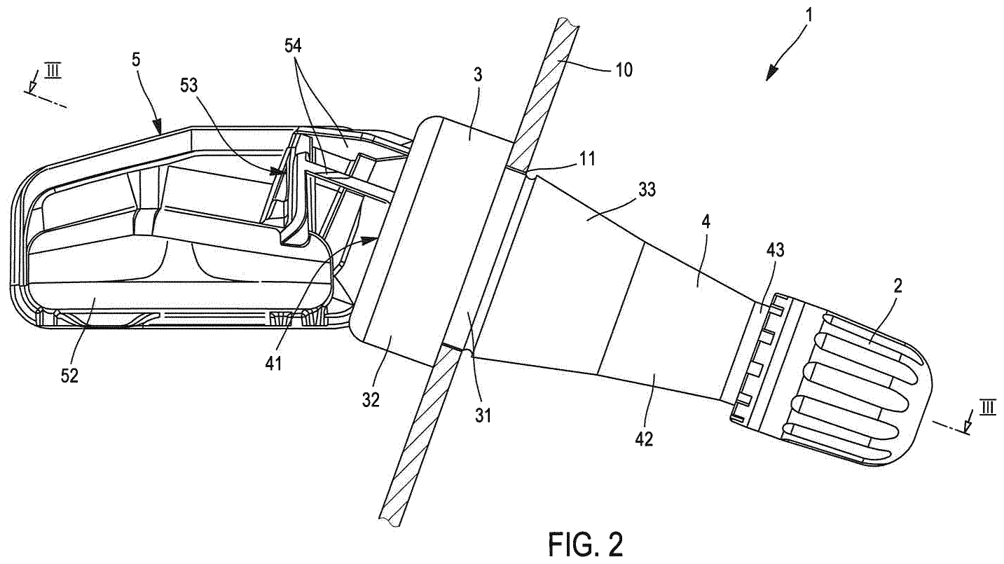

By way of introduction, the term “inside” (INT) and “outside” (EXT) must be understood herein to refer to a positioning inside the tire and outside the tire respectively, relative to the rim as shown in FIGS. 2, 4 and 6.

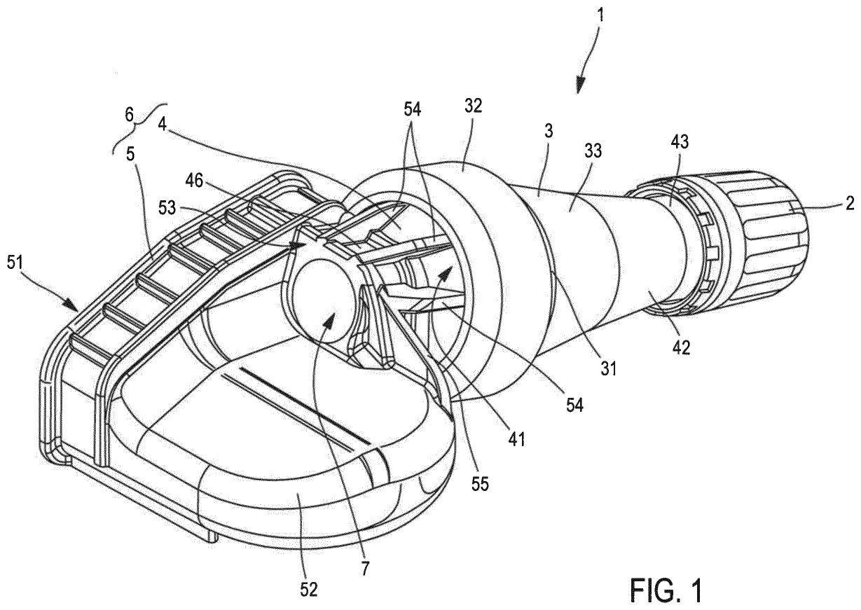

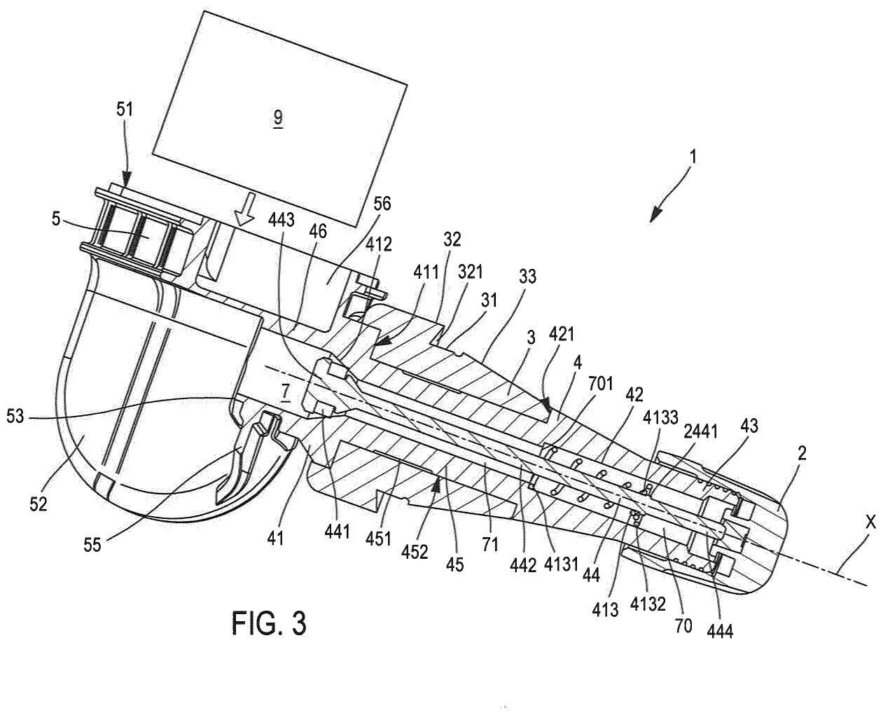

With reference to FIGS. 1 to 3, one embodiment of a tire inflation valve 1 according to an embodiment of the invention is described. The tire inflation valve 1 according to an embodiment of the invention is, in this case, a valve of the TPMS and “snap-in” types. The tire inflation valve 1 according to an embodiment of the invention includes a tubular body 4 which defines a passage 7, 70, 71 having a cylindrical shape rotationally symmetrical about an axis X and extending from an inside end 46 and an outside end 43. The tubular body includes, successively from the outside end 43 to the inside end 46:

engaging structure for placing and holding a protective cap 2 protecting the outside end 43; then,

a frustoconical portion 42 having a fir-tree shape, ending in an outside shoulder 421; then,

a portion 45 including an annular recess 452 longitudinally delimited by the outside shoulder 421 and an inside shoulder 411, an annular groove 451; then,

an inside portion 41 including the inside end 46.

In parallel, the passage 7, 70, 71 defined by the tubular body includes, successively from the outside end 43 to the inside end 46:

an outside part 70; then

a central part 71 having a diameter that is less than a diameter of the outside part 70 and connected thereto by a bearing edge 701; then

an inside part 7 having a larger diameter than the central part 71 and connected thereto by a frustoconical seat 412.

The tire inflation valve 1 according to an embodiment of the invention further includes a valve mechanism 44 positioned in the passage 7, 70, 71. The valve mechanism 44 includes a valve stem 442. The valve stem 442 comprises a head forming a valve shutter 443 on which a sealing member 441 is arranged. Once the valve mechanism is in place in the tubular body, the sealing member 441 bears against the seat 412 of the passage 7, 70, 71, the valve mechanism 44 then being in a closed position preventing at least gas leaks from the inside end. This closed position of the valve mechanism 44 is ensured by return mechanism 413, which in this case include a spring. The sealing member 441 is made, in a non-limiting manner, of a thermosetting polymer, curing polymer or injectable polymer, or is even made of a metal. In an alternative embodiment, the sealing member 441 is formed integrally in one piece with the head forming the valve shutter 443. According to another alternative embodiment, the sealing member is arranged on the seat 412. Once assembled in the passage 7, 70, 71, the valve mechanism 44 shows the head 443 of the valve stem 44 to be positioned in the inside part 7 of the passage 7, 70, 71, with a tip 444 of the valve stem 44 passing through the central part 71 to extend into the outside part 70 in which the return mechanism 413 are located. Moreover, the tip 444 of the valve stem 44 includes a bulge 2441 located in the outside part 70, away from a free end of the tip 444. The tip 444 of the valve stem 44 and the return mechanism 413 form a control assembly for the valve shutter. More specifically, the spring forming the return mechanism 413 has an overall cylindrical-conical shape. It comprises a first coil 4131 forming a large base and having a diameter that is substantially identical to the diameter of the outside part 70. This first coil 4131 bears against the edge 701 connecting the outside part 70 of the passage 7, 70, 71 to the central part 71 thereof. The spring further includes a coil 4133 forming the small base. The coil 4133 bears against the bulge 2441 of the tip 444 of the valve stem 44. When assembling the spring on the valve stem 44, the bulge 2441 is forcibly fitted through the coil 4133. The coil 4133 extends in a concentric manner by way of a widened coil 4132, a diameter whereof is substantially identical to the diameter of the outside part 70. This widened coil 4132 is a radial stabilization and centering coil in the outside part 70 of the valve stem 44.

The valve mechanism 44 is described in more detail in the patent document WO 2016/174323 incorporated herein by reference, and to which reference can be made for more information.

The tire inflation valve 1 according to an embodiment of the invention further includes a resilient element 3 received in the annular recess 452. This resilient element 3 thus surrounds the portion 45 of the tubular body 71 and thus the central part 71 of the passage. From the outside end to the inside end, the resilient element 3 includes a frustoconical part 33, one outside end whereof bears against the outside shoulder 421. The frustoconical part 33 lies in the continuation of the frustoconical portion 42 of the tubular body 4. Then, the resilient element 3 includes an annular sealing surface 31 ending in the direction of the inside end by a shoulder 321. The annular sealing surface 31 is arranged such that it engages with a valve opening 11 made in a thickness of a wheel rim 10 sheet metal, as shown in FIG. 2. Once the resilient element 3 is in place in the annular recess 452, the annular sealing surface 31 is perpendicular to the annular groove 451 of the annular recess 452. Advantageously, the annular groove 452 has a width that exceeds a width of the annular sealing surface 31. This arrangement allows the material of the resilient element 3 located radially beneath the annular sealing surface 31 to be able to migrate into the annular groove 451 once the tire inflation valve 1 according to an embodiment of the invention is positioned in the valve opening 11. More specifically, in order to ensure an optimal airtight seal, the annular sealing surface 31 has a diameter that is greater than a diameter at the valve opening 11, whereby the deformation of this part of the resilient element 3 thus made possible, allows for an optimum airtight seal at said valve opening 11. Then, still in the direction of the inside end, after the shoulder 321, the resilient element 3 includes an end part 32 surrounding the inside shoulder 411 of the annular recess 452 in addition to a part of the inside portion 41 of the tubular body 4. When assembling the resilient element 3 on the tubular body 4, an inner diameter of the resilient element 3 before assembly is less than a diameter of the tubular body in the portion 45 thereof. Thus, the resilient element 3 clamps the tubular body 4 to ensure mechanical adherence allowing:

when assembling the tire inflation valve 1 according to an embodiment of the invention, the resilient element 3 to be maintained under stress, which, by extension, results in a reduction to the outer diameter thereof at an inside end of the frustoconical part 33, then at the annular sealing surface 31, in order to pass into the valve orifice 11 of the rim 10;

a part of the airtight seal to be produced;

mechanical retention of the tire inflation valve 1 according to an embodiment of the invention to be effective.

It should be noted that the structure allowing the sealing part of the valve mechanism 44 to be offset, in this case at the inside end 46, results in:

obtaining a material thickness that is compatible with the compression required for assembly in the valve opening 11 of the rim 10 while having a tubular body wall thickness at the central part 71 of the passage that is compatible with the resistance of the materials injected and a sufficient gas flow area.

preventing fast degassing creating an accident hazard in the case of a breakage at the outside end of the tire inflation valve 1 according to an embodiment of the invention, the sealing part of the valve mechanism 44 thus being inside (INT) the tire.

The tire inflation valve 1 according to an embodiment of the invention further includes a wireless communication unit 5. This wireless communication unit 5 includes a casing 52 including a side opening 51. The wireless communication unit further includes, in a known manner per se, an electronic device 9, in the form of an electronic board for example, in particular equipped with a pressure sensor and a printed circuit board (PCB) and an application-specific integrated circuit (ASIC), allowing measurements to be made and information to be sent to the on-board computer of the motor vehicle, in addition to a power source. The electronic device 9 is inserted, in a removable manner in an alternative embodiment, into the interior 56 of the casing 52 via the opening 51. The latter is then closed. The purpose of the possibility of having a removable electronic device 9 within the casing is to allow the electronic device 9 to be reused in a new tire inflation valve 1 according to an embodiment of the invention in the case of a valve replacement for example. In this case, the casing 52 is located on the inside end 46 of the tubular body 4 of the tire inflation valve 1 according to an embodiment of the invention. The casing 52 is formed integrally in one piece with the tubular body 4. Thus, the tubular body 4 and the casing 52 form a one-piece unit made of the same piece of material. This one-piece unit is simply obtained by molding either using a metal material (for example brass), a composite material or more generally a plastics material. This thus allows the number of parts forming the tire inflation valve 1 according to an embodiment of the invention to be reduced, in addition to the mass thereof. This reduction in mass of the tire inflation valve 1 according to an embodiment of the invention allows for a reduction, when in use, of the centrifugal forces and the induced stresses that cut the resilient element 3, which is generally made of an elastomer, with the edges of the valve orifice 11 of the rim 10, as well as the need for balance weights for the wheel thus equipped with such a tire inflation valve 1 according to an embodiment of the invention.

The tire inflation valve 1 according to an embodiment of the invention includes a joining element 53 between the casing 52 and the tubular body 4. This joining element 53 lies in the continuation of the inside end 46 of the tubular body 4 and extends such that it projects from a side wall of the casing 52. The joining element includes reinforcement ribs 54, 55 connecting the joining element 53 to the tubular body 4 and the casing 52 respectively. A series of reinforcement ribs 54 extend substantially parallel to the longitudinal axis X and connect in particular the joining element 53 to the tubular body 4 at the inside portion 41 thereof. There are three thereof in this case and are distributed over a portion of an outer periphery of the inside end 46. On the other hand, a second reinforcement rib 55 extends substantially perpendicular to the longitudinal axis X of the tubular body 4, connecting the joining element 53 to the casing 52. These reinforcement ribs 54, 55 contribute to the maintenance of the casing 52 on the tubular body 4 in time.

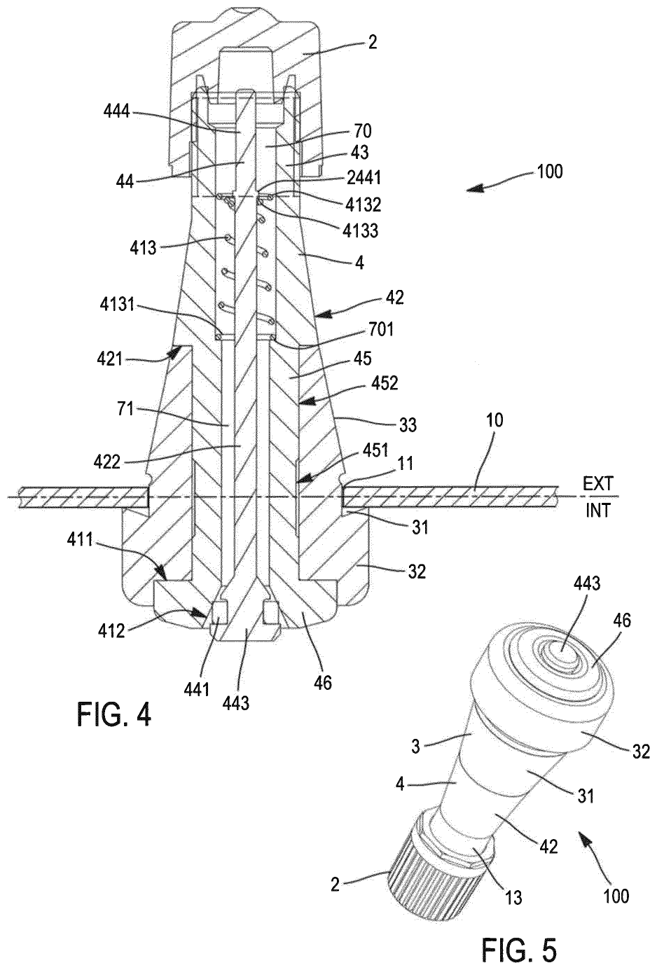

FIGS. 4 and 5 show a tire inflation valve 100 of the “tubeless” type and of the “snap-in” type. This “tubeless” inflation valve 100 differs from the tire inflation valve 1 according to an embodiment of the invention described hereinabove in that the “tubeless” inflation valve 100 does not include a wireless communication unit, nor a joining element between the casing of the wireless communication unit and the tubular body 4. The other elements of the “tubeless” inflation valve 100 are similar to the equivalent elements of the aforementioned tire inflation valve 1 according to an embodiment of the invention. They will not be described again. In particular, the valve mechanism 44 is identical, which allows the sealing part of the valve mechanism 44 to be offset at the inside end 46 of the tubular body 4. Thus, the sealing part of the valve mechanism 44 is inside (INT) the tire, once the “tubeless” inflation valve 100 has been placed through the rim 10. Again, this prevents fast degassing, inter alia, which eliminates an accident hazard in the case of a breakage at the outside end of the “tubeless” inflation valve 100.

According to alternative embodiments, the valves 1 and 100 described hereinabove are of the “clamp-in” type instead of the “snap-in” type.

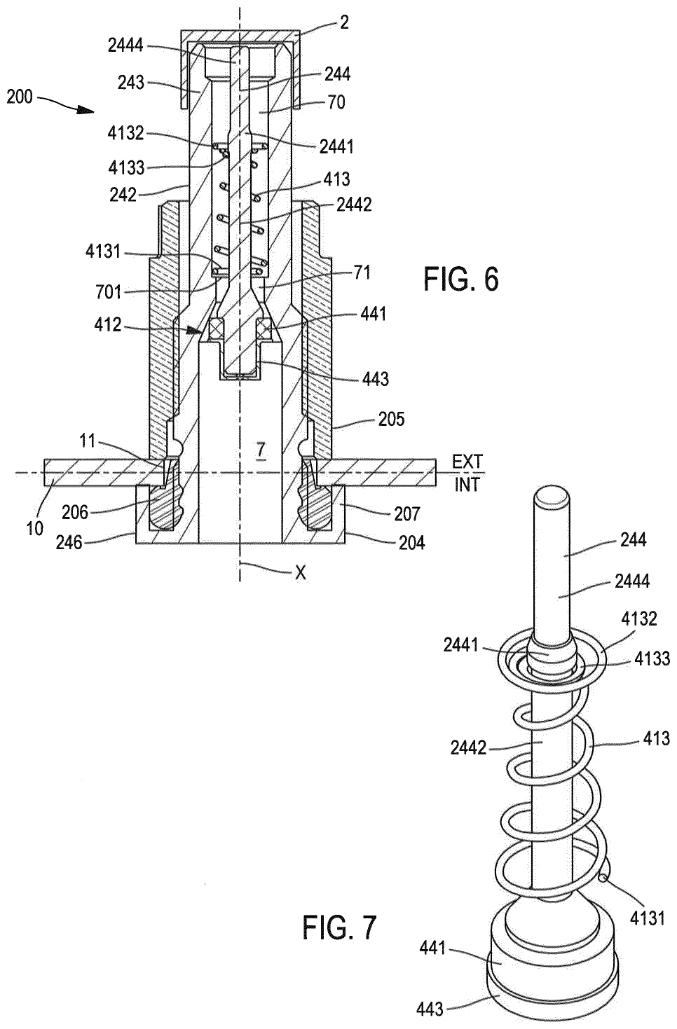

FIGS. 6 and 7 show an alternative embodiment 200 of the tire inflation valve of the “clamp-in” type. The “clamp-in” inflation valve 200 includes a tubular body 204 in which the passage 7, 70, 71 is made. A valve mechanism 244 is positioned in the passage 7, 70, 71. This valve mechanism 244 is very similar to the valve mechanism 44 described hereinabove. The valve mechanism 244 includes a valve stem 2442. The valve stem 2442 comprises a head forming a valve shutter 443 on which a sealing member 441 is arranged. Once the valve mechanism 244 is in place in the tubular body, the sealing member 441 bears against the seat 412 of the passage 7, 70, 71, the valve mechanism 244 thus being in a closed position preventing at least gas leaks from the inside end. This closed position of the valve mechanism 244 is ensured by the return mechanism 413 described hereinabove. Once assembled in the passage 7, 70, 71, the valve mechanism 244 shows the head 443 of the valve stem 244 to be positioned in the inside part 7 of the passage 7, 70, 71, with a tip 2444 of the valve stem 244 passing through the central part 71 to extend into the outside part 70 in which the return mechanism 413 are located. Moreover, the tip 2444 of the valve stem 244 includes a bulge 2441 located in the outside part 70, away from a free end of the tip 2444. The tip 2444 of the valve stem 244 and the return mechanism 413 form control assembly for the valve shutter.

On the other hand, the “clamp-in” inflation valve 200 includes a sealing portion 206 retained in a recess 207 located at the inside end 246. On assembly, the recess 207 is located inside the tire, whereby the sealing portion 206 produces the airtight seal between a periphery of the orifice 11 of the rim 10 and the tubular body 204. Moreover, a clamping nut 205, mounted from the outside, allows the “clamp-in” inflation valve 200 to be held in place on the rim 10.

It should be noted that the structure allowing the sealing part of the valve mechanism 244 to be offset prevents fast degassing creating an accident hazard in the case of a breakage at the outside end of the tire inflation valve 200 according to an embodiment of the invention, the sealing part of the valve mechanism 244 thus being in an area of limited mechanical load area 242, 246 of the tubular body 204, outside of a breakage area located at the outside end 243 of the valve 200. This breakage area corresponds to the part of the tubular body 204 located at the outside end 243 of the tire inflation valve 200 according to an embodiment of the invention, on which the cap 2 is placed and to which a tip of a tire pump is connected. The part of the tubular body of the tire inflation valve 200 according to an embodiment of the invention located between the inside end 246 and the breakage area is the area of a limited mechanical load area. In particular, according to an alternative embodiment, the sealing part is positioned in the vicinity of the orifice 11 for assembling the valve 200 in the rim 10. The term “in the vicinity of the orifice 11” is understood herein to mean that the sealing part is located between the breakage area of the outside end 243 of the valve 200 and a position perpendicular to the orifice 11 while being closer to the position perpendicular to the orifice 11 than to the breakage area of the outside end 243 of the valve 200.

According to an alternative embodiment, the tire inflation valve 200 according to an embodiment of the invention described hereinabove is of the “snap-in” type.

It should be noted that the valve mechanism 244 can be used in the valves 100 and 1 described hereinabove. Moreover, the breakage area and the area of a limited mechanical load area are defined in a similar manner for the valves 1 and 100 according to an embodiment of the invention. Similarly, the valve mechanism 44 can be used in the aforementioned valve 200.

It should be noted that such a structure of a tire inflation valve 1, 100, 200 according to an embodiment of the invention allows a tubular body 4, 204 to be produced, which has an outside part 70, the diameter whereof is less than the diameter required to produce the tapping for receiving a valve mechanism of the prior art, since the thread depth of said unnecessary tapping is recovered to obtain a significantly greater material thickness at the outside part 70, and in particular in the area of breakage of the outside end of the valve, and thus procures improved mechanical strength. This is in addition to the distance separating the outside end of the valve from the sealing part of the valve mechanism 44, 244 described hereinabove.

Secondarily, such a structure of a tire inflation valve 1, 100, 200 according to an embodiment of the invention allows the possible inflation and deflation flow rates to be increased as a result of the absence of any screwed valve mechanism of the prior art which reduces the passage in the tubular body accordingly.

On the other hand, such a structure of a tire inflation valve 1, 100, 200 according to an embodiment of the invention overcomes the clamping restrictions required for the valve mechanism of the prior art. This allows a tubular body 4, 244 to be made from a wide range of materials such as, for example, metal (aluminium, brass, steel, stainless steel, etc.) or plastics (polyamide, polyoxymethylene, polyphenylene sulphide, polyphthalamide, polyimide, polyamide-imide, etc.) charged or otherwise, which list is provided in a non-exhaustive manner.

It goes without saying that numerous modifications can be made to the invention while still remaining within the scope thereof.

1. Tire inflation valve including a tubular body defining a passage and having an inside end and an outside end, a valve mechanism positioned in the passage, the valve mechanism including a valve shutter and a seat arranged so as to engage in an airtight manner with one another, the seat is arranged on the tubular body in the passage, wherein the seat is located in an area of a limited mechanical load area of the tubular body and in that the seat is located at the inside end of the tubular body, so as to be positioned inside the tire when assembling the inflation valve.

2. An inflation valve according to claim 1, wherein the seat is located in the vicinity of an orifice of the tire rim during assembly of the inflation valve.

3. An inflation valve according to claim 1, wherein the valve mechanism comprises control means for controlling the valve shutter which are located at the outside end of the tubular body.

4. An inflation valve according to claim 1, wherein the valve mechanism includes a valve stem comprising a head forming the valve shutter including a sealing member arranged so as to engage in an airtight manner with the seat of the tubular body.

5. An inflation valve according to claim 1, wherein the valve mechanism includes a valve stem comprising a head forming the valve shutter arranged so as to engage in an airtight manner with a sealing member arranged on the seat of the tubular body.

6. An inflation valve according to claim 1, wherein the valve mechanism includes return means for returning to the closed position which are located at the outside end of the tubular body.

7. An inflation valve according to claim 6, wherein the return means comprise a spring.

8. An inflation valve according to claim 7, wherein the spring includes, at one end, a first coil bearing against a bearing edge of the tubular body in the passage and, at an opposite end, a coil connected to the valve shutter and a widened guiding and stabilisation coil.

9. An inflation valve according claim 5, wherein the valve stem includes a bulge engaging with the coil.
